(19) United States
(12) Patent Application Publication
(10) Pub. No.: US 2025/0217729 A1
(43) Pub. Date: Jul. 3, 2025

(54) SIMILAR INTEREST LINKING OF ORGANIZATIONAL MEMBERS

(71) Applicant: Wells Fargo Bank, N.A., San Francisco, CA (US)

(72) Inventor: Christina Marie Dorfman, Fort Mill, SC (US)

(21) Appl. No.: 18/174,982

(22) Filed: Feb. 27, 2023

(51) Int. Cl. G06Q 10/0631

(52) U.S. Cl. CPC G06Q 10/063112

(57) ABSTRACT

Systems and techniques may generally be used to identify similar members of an organization. An example technique may include receiving information corresponding to a plurality of members of the organization, and identifying a set of attribute categories related to the organization. The example technique may include determining, for a first member, a set of similarity scores of the first member to a second member based on attribute values for the first member and the second member in the set of attribute categories. The set of similarity scores may be compared to a closeness threshold. The example technique may include providing a resource or suggested action for the first member in response to a similarity score of the set of similarity scores exceeding the closeness threshold, the resource or the suggested action selected based on the shared attribute category and a portion of the information corresponding to the second member.

### BACKGROUND

Organizations often have many resources, from articles to human resources, internal websites, and the like. Members of these organizations are not always aware of how to access, use, or find these resources, or may not know what resources they need for any given situation. In some cases, members do not know who to ask to find resources. Attempts to connect members of an organization to a resource often rely on subjective human selections.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a diagram showing connected members of an organization in accordance with some embodiments.

FIG. 2 illustrates examples of attribute categories and attribute values in accordance with some embodiments.

FIG. 3 illustrates examples of a resource or a suggested action provided to a user in accordance with some embodiments.

FIG. 4 illustrates machine learning engine for training and execution related to identifying similar members of an organization in accordance with some embodiments.

FIG. 5 illustrates a flowchart showing a technique for identifying similar members of an organization in accordance with some embodiments.

FIG. 6 illustrates generally an example of a block diagram of a machine upon which any one or more of the techniques discussed herein may perform in accordance with some embodiments.

### DETAILED DESCRIPTION

The systems and techniques described herein may be used to identify similar members of an organization. An example technique may include receiving information corresponding to a plurality of members of the organization, and identifying a set of attribute categories related to the organization. The example technique may include determining, for a first member, a set of similarity scores of the first member to a second member based on attribute values for the first member and the second member in the set of attribute categories. The set of similarity scores may be compared to a closeness threshold. The example technique may include providing a resource or a suggested action for the first member in response to a similarity score of the set of similarity scores exceeding the closeness threshold, the resource or the suggested action selected based on the shared attribute category and a portion of the information corresponding to the second member.

The systems and techniques described herein may be used to link nearby members or departments within an organization (e.g., a company, a school, a club, an informal group of people, etc.). An automated process (e.g., using an algorithm, machine learning, etc.) may be used to determine members, departments, or groups that have one or more similar interests, values, alignments, etc. The automated process may be based on members sharing news, processes, job descriptions, by providing feedback, or the like.

In some examples, members may be matched or linked using a Euclidean distance analysis, a kNN analysis, or another distance formula to determine nearby members or departments based on collected information. In other examples, a machine learning model may be used to identify members that share an interest or attribute. The machine learning model may be trained using an organization chart, job descriptions, social media posts, news articles or the like.

An insight may be provided to a member (e.g., a resource, a suggested action such as a recommendation, etc.). In an example, different levels of what is nearby may be applied or used. For example, with a low level group of members or departments, a lunch meeting may be suggested between employees, while a high level group may receive a resource such as a news feed. The levels may be used create an encoding for a group of members, which may be used as a classification for other use (e.g., reorganizations).

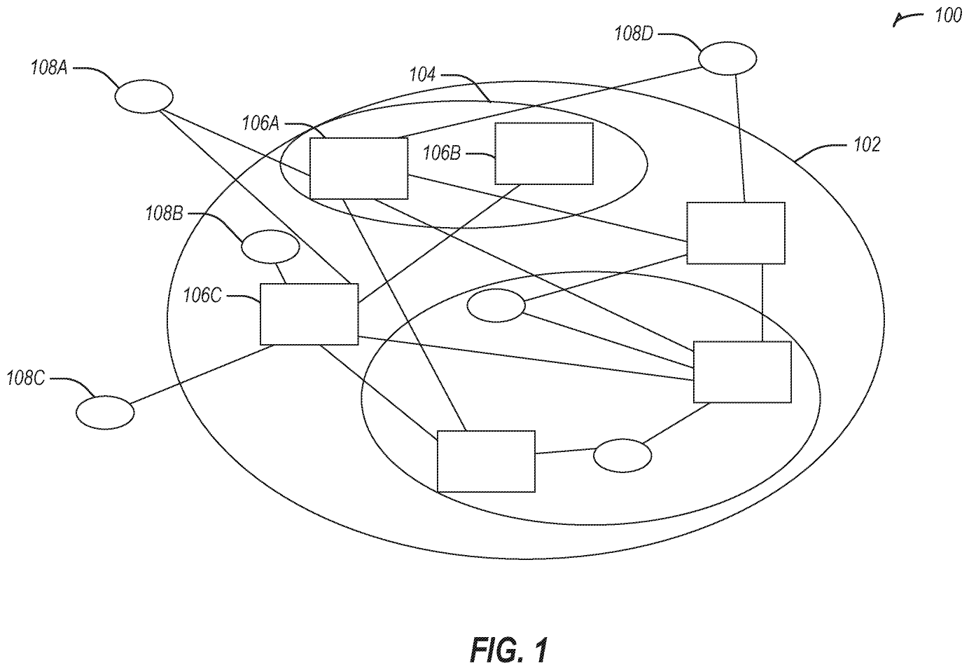

FIG. 1 illustrates a diagram 100 showing connected members of an organization in accordance with some embodiments. The diagram 100 shows connections and organization structures for members of an organization 102. The organization 102 has members, such as member 106A, 106B, and 106C. Members 106A and 106B may be members of a particular group 104 in the organization 102. The diagram 100 shows connections (the lines connecting shapes), which may connect a member to another member or a member to a resource, such as resources 108A, 108B, 108C, or 108D. Some resources, such as 108B are internal organizational resources. Other resources, such as 108A, 108C, and 108D may be external resources (e.g., a website, a document, an event, etc.) that are outside the organization 102. A member may be connected to one or more members. A resource may be connected to one or more members.

In an example, a member, such as member 106C may be identified as a target for determining a related member. The member 106C may be identified by receiving a request from the member 106C, by receiving a request from another member of the organization 102 (e.g., a colleague, a boss, a mentor, a mentee, etc.), based on identification of a group that the member 106C belongs to, by an organizational prompt (e.g., for a yearly review, based on job title, number of years on the job, in consideration of a promotion, etc.). In other examples, a group may be identified or created, such as group 104. One or more members of the group 104 (e.g., members 106A and 106B) may be targeted for determining a related member.

After identifying at least one member to consider, an analysis may be performed to determine a set of similarity scores for the at least one member, compared to one or more other members. The set of similarity scores may be evaluated based on a particular input or attribute of the at least one member under consideration. For example, the member 106C may be interested in further career development. The group 104 may be a mentoring group, where members 106A or 106B offer mentorship. The offer of mentorship may indicate a high similarity score between the members 106A or 106B with the member 106C, who is interested in career development. A lower similarity score may be assigned to a member junior to the member 106C, for example because the junior member has a less developed career at the organization 102 than the member 106C. The similarity scores may be compared to a closeness threshold or ranked. In the career development example, the member 106A may have a similarity score with the member 106C above a closeness threshold for an attribute category of career development (e.g., with attribute values of “looking for career development resources or advice” for the member 106C and “willing to provide mentoring” for the member 106A). After identifying the member 106A as a potential match to the member 106C, a resource or suggested action for the member 106C may be provided (e.g., to the member 106C, to a boss of the member 106C, to another member of the organization 102, or the like). The resource or suggested action may be identified from information corresponding to the member 106A. For example, the resource 108A may be an article, a document, a website, or the like that was useful to the career development or mentoring of the member 106A, and the resource 108A may be shared with the member 106C. In another example, because the member 106A has agreed to provide mentoring, the member 106A may be identified to the member 106C, for example via a calendar invite, a recommendation to connect, an email, etc.

To form the diagram 100 showing the organization 102, including connections between members or resources, an employee resource network or employee learning opportunity board may be used. The members of the organization 102 may rely on a similarity score (e.g., one that exceeds a closeness threshold) to avoid duplicating work in some examples. The similarity score may digitally identify a member that has previously or is currently performing a similar task, job, or service. The similarity score may be used to eliminate the need to search newsletters or articles for career development or a career path, for example. In an example, the member 106C may have accessed the resource 108A (e.g., read an article, clicked on a link, etc.), and based on that interaction, member 106A may be identified (e.g., as also having accessed the resource 108A, or as someone otherwise linked to resource 108A). After identifying member 106A, the member 106C may be provided a recommendation or suggested action based on actions by or attributes of member 106A, such as a suggestion to email or meet with member 106A, a suggestion to access resource 108D, a suggestion to join group 104, etc. In some examples, a suggestion or recommendation may not identify any other member (e.g., not identify the member with the close similarity score), and instead provide information such as, “Did you know this resource was available to you?” This example may appear more organic to the member requesting information, and may help protect the identity of the close other member (e.g., in cases where the resource is sensitive, such as a member needing help with healthcare resources at the organization 102).

The group 104 may be generated based on similarity scores of a set of members, such as members 106A and 106B (e.g., where those two or more members have similarity scores that exceed a closeness threshold). Suggested actions or resources may be sent to members of the group 104 based on actions of group members or based on actions of a member outside the group 104, who has an identified similarity score that exceeds a closeness threshold (which may or may not qualify the member outside the group 104 for membership in the group 104). The group 104 may be generated via a classifier or machine learning model, such as by training the classifier or model on members who have accessed similar resources, met together, or otherwise participated in similar or related activities or actions. Information for training or outputting information from a classifier or model may include using a notification based on an event (e.g., a review coming up), using information about a member, such as a job title to indicate an article, core competencies of a job you have, a job you want, etc. The suggestions or recommendations may be operated via an opt-in service for networking information or opportunities. In some examples, opting in may be dependent on details provided by a member, such as a specialty, triggered by a policy change such as risk or new law, or the like. A member may be presented with an option to receive information, such as by selecting a prompt to “show me something new” or “show me something related but not overlapping to a topic.” The information may be provided periodically in some examples, such as weekly, monthly, etc.

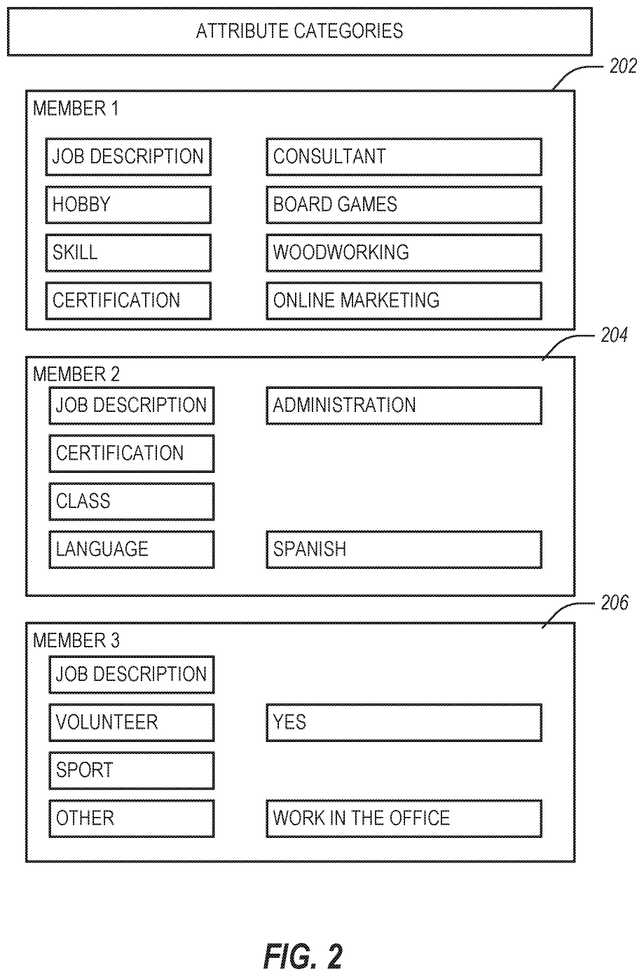

FIG. 2 illustrates examples of attribute categories and attribute values in accordance with some embodiments. Attribute categories may include categories of attributes of a member of an organization, such as a job description, a hobby, a skill, a certification, a class taken, a course, a language, experience (e.g., leadership experience, volunteer experience, etc.), a sport, or the like. Each attribute category may have one or more attribute values (e.g., in some cases the attribute value may be yes/no, some may have a list such as languages, while others may be open ended such as job descriptions). Example attribute categories and values for some members 202, 204, and 206 of an organization are shown in FIG. 2.

A first member 202 has example attribute categories with values, such as a job description of consultant, a hobby of board games, a skill of woodworking, and a certification of online marketing. A second member 204 has example attribute categories with values and a few without, such as job description administration, and language Spanish, along with categories with no value of certification and class (e.g., school). While no value is listed for the categories, in some examples the categories may be selected (e.g., by the second member 204 or by an algorithm, a classifier, or machine learning model) for determining a similarity score. In these examples, the attribute category itself may be used as an input or output for consideration of similarity or suggested action or resource. For example, the second member 204 may be interested in taking a class that other people with language Spanish have taken. In this example, a value may be selected for the class attribute category based on similarity scores related to language Spanish for the second member 204 (e.g., with potential other considerations such as location, timing, etc.). A third member 206 has example attribute categories of volunteer “yes” and “other”—“work in the office” along with valueless categories of job description and sport. In some examples, a physical location (e.g., current, future, stated, or obtained automatically, etc.) may be used as a category. For example, a future physical location such as “in office 123 on May 1” may be used as a value. In an example, the third member 206 and the first member 202 may have a same job title, and the third member 206 may be encouraged based on a similarity score of job title to fill out a job description (e.g., be automatically presented with the job description of “consultant” of the first member 202).

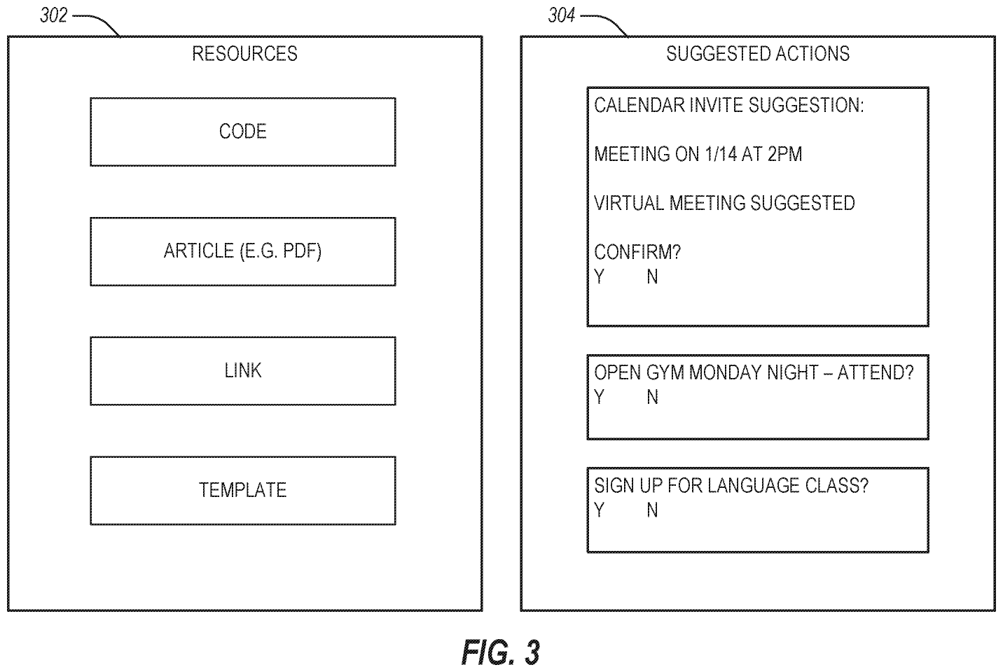

FIG. 3 illustrates examples of a resource or a suggested action provided to a user in accordance with some embodiments. Example resources 302 and suggested actions 304 are shown in FIG. 3. Example resources 302 may include code (e.g., computer code, pseudo code, an algorithm, a program, an application, an app, an executable, a snippet, etc.), an article (e.g., a PDF article, an article on a webpage, a physical article, a book, a blog post, etc.), a link such as to a website, a template (e.g., a document template, an email template, a spreadsheet template, a code template, a drawing template, etc.), or the like. The example suggested actions 304 may include suggesting a scheduled meeting time between a first member and a second member (e.g., as shown via a calendar invite suggestion, which may be confirmed or rejected), a suggestion to attend a class, meeting, etc., (e.g., the open gym Monday night recommendation or the language class sign up recommendation of FIG. 3), or the like.

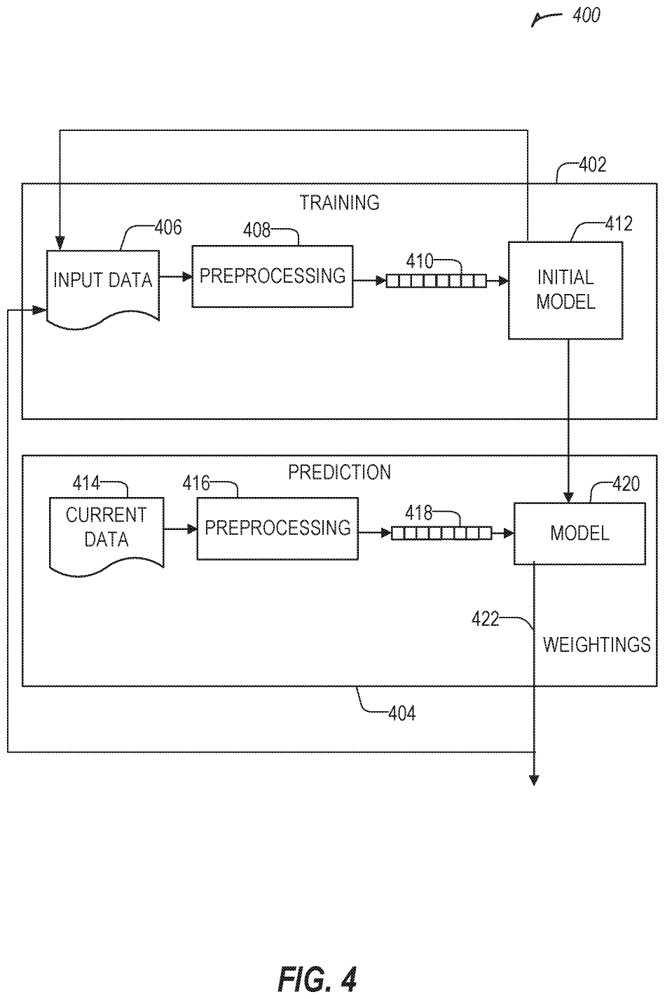

FIG. 4 illustrates machine learning engine for training and execution related to identifying similar members of an organization in accordance with some embodiments. The machine learning engine may be deployed to execute at a mobile device (e.g., a cell phone) or a computer (e.g., an orchestrator server). A system may calculate one or more weightings for criteria based upon one or more machine learning algorithms. FIG. 4 shows an example machine learning engine 400 according to some examples of the present disclosure.

Machine learning engine 400 uses a training engine 402 and a prediction engine 404. Training engine 402 uses input data 406, for example after undergoing preprocessing component 408, to determine one or more features 410. The one or more features 410 may be used to generate an initial model 412, which may be updated iteratively or with future labeled or unlabeled data (e.g., during reinforcement learning), for example to improve the performance of the prediction engine 404 or the initial model 412.

The input data 406 may include attribute categories or attribute values, such as a job description, a hobby, a skill, a certification, a class taken, a course, a language, experience (e.g., leadership experience, volunteer experience, etc.), a sport, or the like. In some examples, access to an attribute category, attribute value, or use of any or all data may be controlled by a user. For example, the user may initially opt in to some or all of use of one or more attribute category, value, or data. The user may then opt out of use of one or more attribute category, value, or data at a later time, for example when there is no longer interest associated to a particular attribute.

In the prediction engine 404, current data 414 (e.g., information corresponding to an attribute category or attribute value) may be input to preprocessing component 416. In some examples, preprocessing component 416 and preprocessing component 408 are the same. The prediction engine 404 produces feature vector 418 from the preprocessed current data, which is input into the model 420 to generate one or more criteria weightings 422. The criteria weightings 422 may be used to output a prediction, as discussed further below.

The training engine 402 may operate in an offline manner to train the model 420 (e.g., on a server). The prediction engine 404 may be designed to operate in an online manner (e.g., in real-time, at a mobile device, on a wearable device, etc.). In some examples, the model 420 may be periodically updated via additional training (e.g., via updated input data 406 or based on labeled or unlabeled data output in the weightings 422) or based on identified future data, such as by using reinforcement learning to personalize a general model (e.g., the initial model 412) to a particular user. In some examples, the model 420 may be updated automatically using public or private information (e.g., publicly available certifications, job databases, etc., or private job titles or job descriptions in an organization).

Labels for the input data 406 may include a portion of code, an article, a trained model, an algorithm, a career path, a mentor, a calendar entry, a certification, a job description, a portion of code, an organizational title, an organizational chart, a leadership role, a committee membership, a social group membership, or a school class. The labels may identify a resource used or accessed or an action taken or to be taken by a member of an organization. The input data 406 for the labels may include attributes or actions taken by the member as described above.

In some examples, labels may use specified rulesets (such as if-then rules), machine learned models, or the like that use description data of members as input to decide as to which group a member belongs. Example machine-learning algorithms include machine-learned clustering algorithms. In some examples, the clustering algorithms may be supervised in that each member may have a label of which group the member should be placed into. The label may be determined by an administrator, or by members themselves in the early stages of an example implementation. That is, in the early stages of deployment, users may pick the member group they feel they best belong in. This label, along with the member description data may be used to train a model that may be used during later stages, where a member group may be suggested or assigned automatically based upon the model. I other examples, the machine-learning algorithm may be unsupervised.

The initial model 412 may be updated using further input data 406 until a satisfactory model 420 is generated. The model 420 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 402 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 402. In an example embodiment, a regression model is used and the model 420 is a vector of coefficients corresponding to a learned importance for each of the features in the vector of features 410, 418. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 420 may determine a similarity score for one or more members of an organization. The similarity score may be compared to a closeness threshold (e.g., to indicate whether the one or more members share an attribute category or attribute value with a subject member). In some examples, the model 420 outputs the one or more members when the similarity score exceeds the closeness threshold, while in other examples the model 420 outputs the similarity score for later use. In some examples, the model 420 may output a suggested action or a resource for a member of an organization, based on a determined similarity score (and optionally a closeness threshold). For example, the model 420 may output a suggested scheduled meeting time between two members of an organization, code to be sent from one member to another of the organization, a link to an article, a website, or the like.

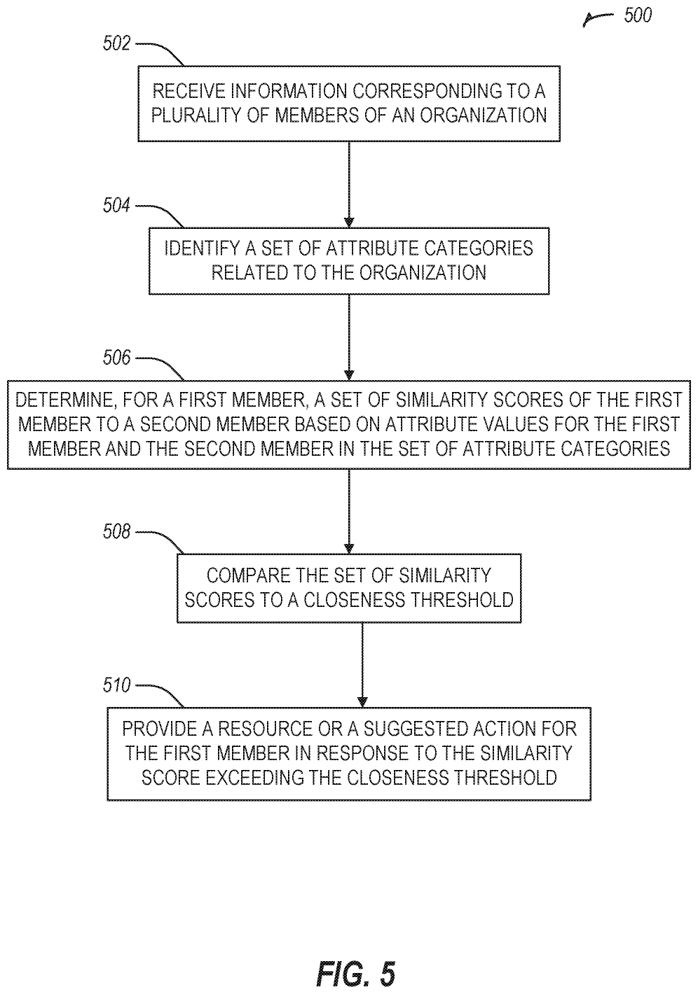

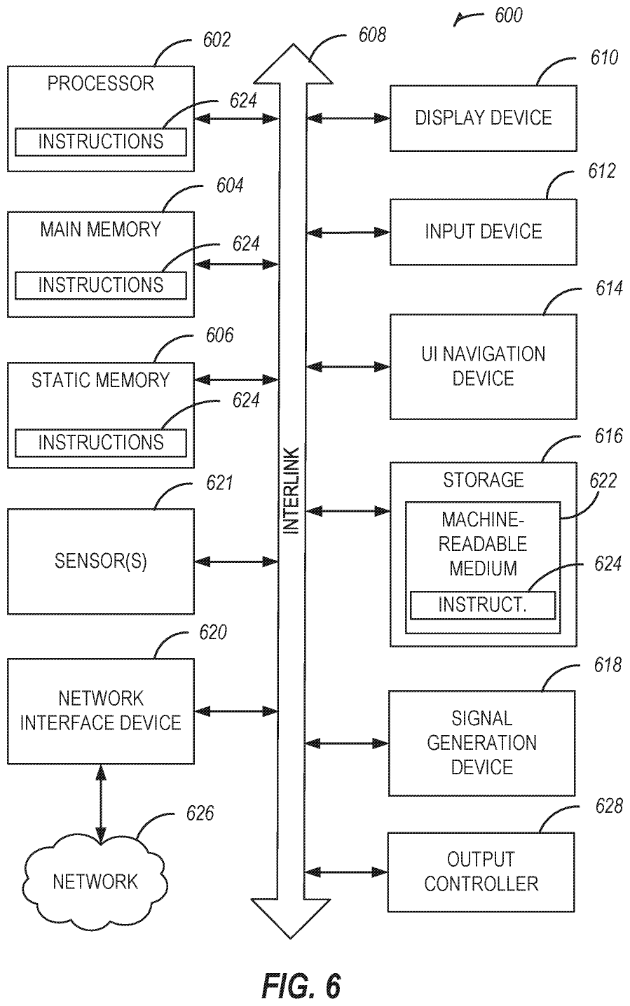

FIG. 5 illustrates a flowchart showing a technique 500 for identifying similar members of an organization in accordance with some embodiments. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 6.

The technique 500 includes an operation 502 to receive information corresponding to a plurality of members of an organization. The information may include user interactions with a website, an article, a document, an email, a meeting, an organization chart of the organization, a physical location, a physical proximity, or the like. In an example, when there is a high similarity score and most of a user's network has a meeting at a particular time, for example 9:00 am, a recommendation may be sent to the user to attend the meeting. The information may include a skills inventory of the plurality of members of the organization.

The technique 500 includes an operation 504 to identify a set of attribute categories related to the organization. The set of attribute categories may include a job description, a hobby, a skill, a certification, a class taken, a course, a language, experience (e.g., leadership experience, volunteer experience, etc.), a sport, or the like.

The technique 500 includes an operation 506 to determine, for a first member (e.g., of the plurality of members), a set of similarity scores of the first member to a second member (e.g., of the plurality of members) based on attribute values for the first member and the second member in the set of attribute categories. Operation 506 may include using a trained machine learning model. In another example, operation 506 includes using a distance formula.

The technique 500 includes an operation 508 to compare the set of similarity scores to a closeness threshold. The closeness threshold may indicate whether the first member and the second member share an attribute category.

The technique 500 includes an operation 510 to provide a resource or a suggested action for the first member in response to a similarity score of the set of similarity scores exceeding the closeness threshold. The resource or the suggested action may be selected based on the shared attribute category and a portion of the information corresponding to the second member. The portion of the information corresponding to the second member may include at least one of a portion of code, an article, a trained model, an algorithm, a career path, a mentor, a calendar entry, a certification, a job description, a portion of code, an organizational title, a leadership role, a committee membership, a social group membership, a school class, or the like. Operation 510 may also be performed in response to a second similarity score of the set of similarity scores exceeding a second closeness threshold for a second attribute category of the set of attribute categories. Operation 510 may include at least one of suggesting a scheduled meeting time between the first member and the second member, sending code from the second member to the first member, sending a link to an article to the first member, or the like.

The technique 500 may include in response to a similarity score of the set of similarity scores exceeding the closeness threshold, adding the first member to a group of the organization that the second member is already in. The technique 500 may include identifying a second similarity score of the set of similarity scores that falls below a second closeness threshold for a second attribute category of the set of attribute categories, and wherein the resource or the suggested action correspond to the second attribute category. For example, the second similarity score that falls below the second closeness threshold may be indicative of an attribute, skill, meeting, resource, etc. that the first member has not accessed, achieved, completed etc., and that the second member has. Thus, this information may be used to recommend that the first member follow the second member's action regarding this attribute, skill, meeting, resource, etc. The second similarity score may be used in combination with the first similarity score. For example, the first similarity score maybe used to identify the second member having a shared attribute category or value with the first member, and the second similarity score may be used to identify an action for the first member based on actions by the second member.

FIG. 6 illustrates generally an example of a block diagram of a machine 600 upon which any one or more of the techniques (e.g., methodologies) discussed herein may perform in accordance with some embodiments. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.
Example 1 is a method comprising: receiving information corresponding to a plurality of members of an organization; identifying a set of attribute categories related to the organization; determining, for a first member of the plurality of members, a set of similarity scores of the first member to a second member of the plurality of members based on attribute values for the first member and the second member in the set of attribute categories using a trained machine learning model; comparing, using processing circuitry, the set of similarity scores to a closeness threshold, the closeness threshold indicating whether the first member and the second member share an attribute category; and providing a resource or a suggested action for the first member in response to a similarity score of the set of similarity scores exceeding the closeness threshold, the resource or the suggested action selected based on the shared attribute category and a portion of the information corresponding to the second member.
In Example 2, the subject matter of Example 1 includes, wherein the portion of the information corresponding to the second member includes at least one of a portion of code, an article, a trained model, an algorithm, a career path, a mentor, a calendar entry, a certification, a job description, a portion of code, an organizational title, a leadership role, a committee membership, a social group membership, or a school class.
In Example 3, the subject matter of Examples 1-2 includes, wherein the information includes user interactions with a website, an article, a document, an email, a meeting, or an organizational chart of the organization.
In Example 4, the subject matter of Examples 1-3 includes, wherein providing the resource or suggested action occurs in response to a second similarity score of the set of similarity scores exceeding a second closeness threshold for a second attribute category of the set of attribute categories.
In Example 5, the subject matter of Examples 1-4 includes, wherein providing the resource or the suggested action includes at least one of suggesting a scheduled meeting time between the first member and the second member, sending code from the second member to the first member, or sending a link to an article to the first member.
In Example 6, the subject matter of Examples 1-5 includes, in response to the similarity score exceeding the closeness threshold, adding the first member to a group of the organization that the second member is already in.
In Example 7, the subject matter of Examples 1-6 includes, wherein the information includes a skills inventory of the plurality of members of the organization.
In Example 8, the subject matter of Examples 1-7 includes, identifying a second similarity score of the set of similarity scores that falls below a second closeness threshold for a second attribute category of the set of attribute categories, and wherein the resource or the suggested action correspond to the second attribute category.
Example 9 is at least one non-transitory machine-readable medium including instructions, which when executed by processing circuitry, cause the processing circuitry to perform operations to: receive information corresponding to a plurality of members of an organization; identify a set of attribute categories related to the organization; determine, for a first member of the plurality of members, a set of similarity scores of the first member to a second member of the plurality of members based on attribute values for the first member and the second member in the set of attribute categories using a distance formula; compare the set of similarity scores to a closeness threshold, the closeness threshold indicating whether the first member and the second member share an attribute category; and provide a resource or a suggested action for the first member in response to a similarity score of the set of similarity scores exceeding the closeness threshold, the resource or the suggested action selected based on the shared attribute category and a portion of the information corresponding to the second member.
In Example 10, the subject matter of Example 9 includes, wherein the portion of the information corresponding to the second member includes at least one of a portion of code, an article, a trained model, an algorithm, a career path, a mentor, a calendar entry, a certification, a job description, a portion of code, an organizational title, a leadership role, a committee membership, a social group membership, or a school class.
In Example 11, the subject matter of Examples 9-10 includes, wherein the information includes user interactions with a website, an article, a document, an email, a meeting, or an organizational chart of the organization.
In Example 12, the subject matter of Examples 9-11 includes, wherein to provide the resource or suggested action occurs in response to a second similarity score of the set of similarity scores exceeding a second closeness threshold for a second attribute category of the set of attribute categories.
In Example 13, the subject matter of Examples 9-12 includes, wherein to provide the resource or the suggested action includes at least one of suggesting a scheduled meeting time between the first member and the second member, sending code from the second member to the first member, or sending a link to an article to the first member.
In Example 14, the subject matter of Examples 9-13 includes, operations to, in response to the similarity score exceeding the closeness threshold, add the first member to a group of the organization that the second member is already in.
In Example 15, the subject matter of Examples 9-14 includes, wherein the information includes a skills inventory of the plurality of members of the organization.
In Example 16, the subject matter of Examples 9-15 includes, operations to identify a second similarity score of the set of similarity scores that falls below a second closeness threshold for a second attribute category of the set of attribute categories, and wherein the resource or the suggested action correspond to the second attribute category.
Example 17 is a system comprising: processing circuitry; memory, including instructions, which when executed by the processing circuitry, causes the processing circuitry to: receive information corresponding to a plurality of members of an organization; identify a set of attribute categories related to the organization; determine, for a first member of the plurality of members, a set of similarity scores of the first member to a second member of the plurality of members based on attribute values for the first member and the second member in the set of attribute categories using a trained machine learning model; compare the set of similarity scores to a closeness threshold, the closeness threshold indicating whether the first member and the second member share an attribute category; and provide a resource or a suggested action for the first member in response to a similarity score of the set of similarity scores exceeding the closeness threshold, the resource or the suggested action selected based on the shared attribute category and a portion of the information corresponding to the second member.
In Example 18, the subject matter of Example 17 includes, wherein the portion of the information corresponding to the second member includes at least one of a portion of code, an article, a trained model, an algorithm, a career path, a mentor, a calendar entry, a certification, a job description, a portion of code, an organizational title, a leadership role, a committee membership, a social group membership, or a school class.
In Example 19, the subject matter of Examples 17-18 includes, wherein to provide the resource or the suggested action includes at least one of suggesting a scheduled meeting time between the first member and the second member, sending code from the second member to the first member, or sending a link to an article to the first member.
In Example 20, the subject matter of Examples 17-19 includes, operations to identify a second similarity score of the set of similarity scores that falls below a second closeness threshold for a second attribute category of the set of attribute categories, and wherein the resource or the suggested action correspond to the second attribute category.
Example 21 is at least one machine-readable medium including instructions that, when executed by processing circuitry, cause the processing circuitry to perform operations to implement of any of Examples 1-20.
Example 22 is an apparatus comprising means to implement of any of Examples 1-20.
Example 23 is a system to implement of any of Examples 1-20.
Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

1. A method comprising:
receiving information corresponding to a plurality of members of an organization;
identifying a set of attribute categories related to the organization;
determining attribute values for a first member of the plurality of members for the set of attribute categories;
processing the attribute values for the first member to generate a first feature vector;
determining attribute values for a second member of the plurality of members for the set of attribute categories;
processing the attribute values for the second member to generate a second feature vector;
inputting the first feature vector and second feature vector into a trained machine learning model, the trained machine learning model including stored criteria weights based on past labeled data associated with the set of attribute categories;
in response to the inputting, receiving a set of similarity scores from the trained machine learning model for the set of attribute categories;
comparing, using processing circuitry, the set of similarity scores to a closeness threshold, the closeness threshold indicating whether the first member and the second member share an attribute category;
determining a similarity score of the set of similarity scores exceeds the closeness threshold;
based on the determining the similarity score exceeds the closeness threshold, selecting using the trained machine learning model a resource to provide to the second member based on a portion of information of the second member and the shared attribute category, the portion of information including a portion of code of the second member; and
providing the portion of code of the second member to the first member.

2. The method of claim 1, wherein the portion of the information of the second member includes at least one of an article, a trained model, an algorithm, a career path, a mentor, a calendar entry, a certification, a job description, an organizational title, a leadership role, a committee membership, a social group membership, or a school class.

3. The method of claim 1, wherein the portion of information includes user interactions with a website, an article, a document, an email, a meeting, or an organizational chart of the organization.

4. The method of claim 1, wherein selecting the resource is in response to a second similarity score of the set of similarity scores exceeding a second closeness threshold for a second attribute category of the set of attribute categories.

5. (canceled)

6. The method of claim 1, further comprising, in response to determining the similarity score exceeding the closeness threshold, adding the first member to a group of the organization that the second member is already in.

7. The method of claim 1, wherein the portion of information includes a skills inventory of the plurality of members of the organization.

8. (canceled)

9. At least one non-transitory machine-readable medium including instructions, which when executed by processing circuitry, cause the processing circuitry to perform operations to:
receive information corresponding to a plurality of members of an organization;
identify a set of attribute categories related to the organization;
determine attribute values for a first member of the plurality of members for the set of attribute categories;
process the attribute values for the first member to generate a first feature vector;
determine attribute values for a second member of the plurality of members for the set of attribute categories;
processing the attribute values for the second member to generate a second feature vector;
input the first feature vector and second feature vector into a trained machine learning model, the trained machine learning model including stored criteria weights based on past labeled data associated with the set of attribute categories;
in response to the inputting, receive a set of similarity scores from the trained machine learning model for the set of attribute categories;
compare the set of similarity scores to a closeness threshold, the closeness threshold indicating whether the first member and the second member share an attribute category;
determine a similarity score of the set of similarity scores exceeds the closeness threshold;
based on the determining the similarity score exceeds the closeness threshold, select using the trained machine learning model a resource to provide to the second member based on a portion of information of the second member and the shared attribute category, the portion of information including a portion of code of the second member; and
providing the portion of code of the second member to the first member.

10. The at least one machine-readable medium of claim 9, wherein the portion of the information of the second member includes at least one of an article, a trained model, an algorithm, a career path, a mentor, a calendar entry, a certification, a job description, an organizational title, a leadership role, a committee membership, a social group membership, or a school class.

11. The at least one machine-readable medium of claim 9, wherein the portion of information includes user interactions with a website, an article, a document, an email, a meeting, or an organizational chart of the organization.

12. The at least one machine-readable medium of claim 9, wherein to select the resource is in response to a second similarity score of the set of similarity scores exceeding a second closeness threshold for a second attribute category of the set of attribute categories.

13. (canceled)

14. The at least one machine-readable medium of claim 9, further comprising operations to, in response to determining the similarity score exceeds the closeness threshold, add the first member to a group of the organization that the second member is already in.

15. The at least one machine-readable medium of claim 9, wherein the portion of information includes a skills inventory of the plurality of members of the organization.

16. (canceled)

17. A system comprising:
processing circuitry; and
memory, including instructions, which when executed by the processing circuitry, causes the processing circuitry to:
receive information corresponding to a plurality of members of an organization;
identify a set of attribute categories related to the organization;
determine attribute values for a first member of the plurality of members for the set of attribute categories;
process the attribute values for the first member to generate a first feature vector;
determine attribute values for a second member of the plurality of members for the set of attribute categories;
processing the attribute values for the second member to generate a second feature vector;
input the first feature vector and second feature vector into a trained machine learning model, the trained machine learning model including stored criteria weights based on past labeled data associated with the set of attribute categories;
in response to the inputting, receive a set of similarity scores from the trained machine learning model for the set of attribute categories;
compare the set of similarity scores to a closeness threshold, the closeness threshold indicating whether the first member and the second member share an attribute category;
determine a similarity score of the set of similarity scores exceeds the closeness threshold;
based on the determining the similarity score exceeds the closeness threshold, select using the trained machine learning model a resource to provide to the second member based on a portion of information of the second member and the shared attribute category, the portion of information including a portion of code of the second member; and
providing the portion of code of the second member to the first member.

18. The system of claim 17, wherein the portion of the information corresponding to the second member includes at least one of a portion of code, an article, a trained model, an algorithm, a career path, a mentor, a calendar entry, a certification, a job description, a portion of code, an organizational title, a leadership role, a committee membership, a social group membership, or a school class.

19. The system of claim 17, wherein to provide the resource or the suggested action includes at least one of suggesting a scheduled meeting time between the first member and the second member, sending code from the second member to the first member, or sending a link to an article to the first member.

20. The system of claim 17, further comprising operations to identify a second similarity score of the set of similarity scores that falls below a second closeness threshold for a second attribute category of the set of attribute categories, and wherein the resource or the suggested action correspond to the second attribute category.
